(19) United States
(12) Patent Application Publication
(10) Pub. No.: US 2017/0048445 A1
(43) Pub. Date: Feb. 16, 2017

(54) METHOD FOR CONTROLLING AN IMAGE ACQUISITION DEVICE, AND A BICYCLE

(71) Applicants: Le Holdings(Beijing)Co., Ltd., Beijing (CN); LETV SPORTS CULTURE DEVELOP(BEIJING) CO., LTD., Beijing (CN)

(72) Inventor: Dalong LI, Beijing (CN)

(21) Appl. No.: 15/232,412

(22) Filed: Aug. 9, 2016

Related U.S. Application Data
(63) Continuation of application No. PCT/CN2016/081989, filed on May 13, 2016.

(30) Foreign Application Priority Data
Aug. 11, 2015 (CN) 201510491510.8

(51) Int. Cl. H04N 5/232; B62J 99/00; B62J 6/00; H04N 5/225; B62J 6/02

(52) U.S. Cl. CPC H04N 5/23203; H04N 5/23245; H04N 5/2252; B62J 6/02; B62J 6/001; B62J 99/00; B62J 2099/0013; B62J 2099/004

(57) ABSTRACT

Embodiments of the invention provide a method for controlling an image acquisition device, and a bicycle including a bicycle body, wherein the bicycle further includes: a main control apparatus, a button arranged on the bicycle body, and an image acquisition device fixed on the bicycle body, wherein the main control apparatus is connected with the button and the image acquisition device so that the main control apparatus is configured to control the image acquisition device as a result of the button being triggered. In the invention, the image acquisition device is fixed on the bicycle body, and the button is arranged on the bicycle body, so that if a bicycler triggers the button while bicycling, then the main control apparatus can control the image acquisition device as a result of the button being triggered.

### CROSS REFERENCE TO RELATED APPLICATIONS

This application is a continuation of International Application No. PCT/CN2016/081989, with an international filing date of filed May 13, 2016, which is based upon and claims priority to Chinese Patent Application No. 201510491510.8, filed on Aug. 11, 2015, the entire contents of all of which are incorporated herein by reference.

### TECHNICAL FIELD

The present invention relates to the field of bicycles, and particularly to a method for controlling an image acquisition device, and a bicycle.

### BACKGROUND

At present, bicycling has become increasingly popular as a low-carbon, environment-conserving, and healthy sporting and traveling mode. Many bicycling users prefer to produce videos or take pictures using cameras and other image acquisition devices to thereby record memorable instances while they are bicycling.

The bicycling users (bicyclers) have to stop bicycling and to take out their cameras and other image acquisition devices to take pictures or to produce videos instead of taking the pictures or producing the videos while bicycling.

In view of this, it is highly desirable at present in the industry to enable a bicycling user to start an image acquisition device while bicycling so that the bicycling user can take a picture or produce a video while bicycling.

### SUMMARY

Embodiments of the invention provide a method for controlling an image acquisition device, and a bicycle so as to address the drawback in the prior art that the bicycling user has to stop bicycling and to start the image acquisition device to take a picture or to produce a video, so that the bicycling user can control the image acquisition device by operating on a button on the bicycle.

In one aspect, embodiments of the invention provides a bicycle including a bicycle body, wherein the bicycle further includes:

a main control apparatus, a button arranged on the bicycle body, and an image acquisition device fixed on the bicycle body, wherein the main control apparatus is connected with the button and the image acquistion device so that the main control apparatus is configured to control the image acquisition device as a result of the button being triggered.

In another aspect, embodiments of the invention provides a method for controlling an image acquisition device, the method including:

connecting a main control apparatus with a button and an image acquisition device, wherein the main control apparatus controls the image acquisition device as a result of the button being triggered.

In the method for controlling an image acquisition device, and the bicycle according to the embodiments of the invention, the image acquisition device is fixed on the bicycle body, and the button is arranged on the bicycle body, so that if a bicycler triggers the button while bicycling, then the main control apparatus can control the image acquisition device as a result of the button being triggered, and in this way, the bicycler can control the image acquisition device by triggering the button on the bicycle body while bicycling, so that the bicycler can operate conveniently, and be avoided from stopping bicycling to control the image acquisition device to take a picture or to produce a video, thus improving the experience of the bicycler.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic structural diagram of a bicycle according to some embodiments;

FIG. 2 is a schematic explosively structural diagram of a main control apparatus cooperating with a bicycle body of the bicycle according to some embodiments;

FIG. 3 is a first schematic flow chart of a method for controlling an image acquisition device according to some embodiments; and

FIG. 4 is a second schematic flow chart of a method for controlling an image acquisition device according to some embodiments.

### DETAILED DESCRIPTION

In order to make the objects, technical solutions, and advantages of the embodiments of the invention more apparent, the technical solutions according to the embodiments of the invention will be described below clearly and fully with reference to the drawings in the embodiments of the invention, and apparently the embodiments described below are only a part but not all of the embodiments of the invention. Based upon the embodiments here of the invention, all the other embodiments which can occur to those skilled in the art without any inventive effort shall fall into the scope of the invention.

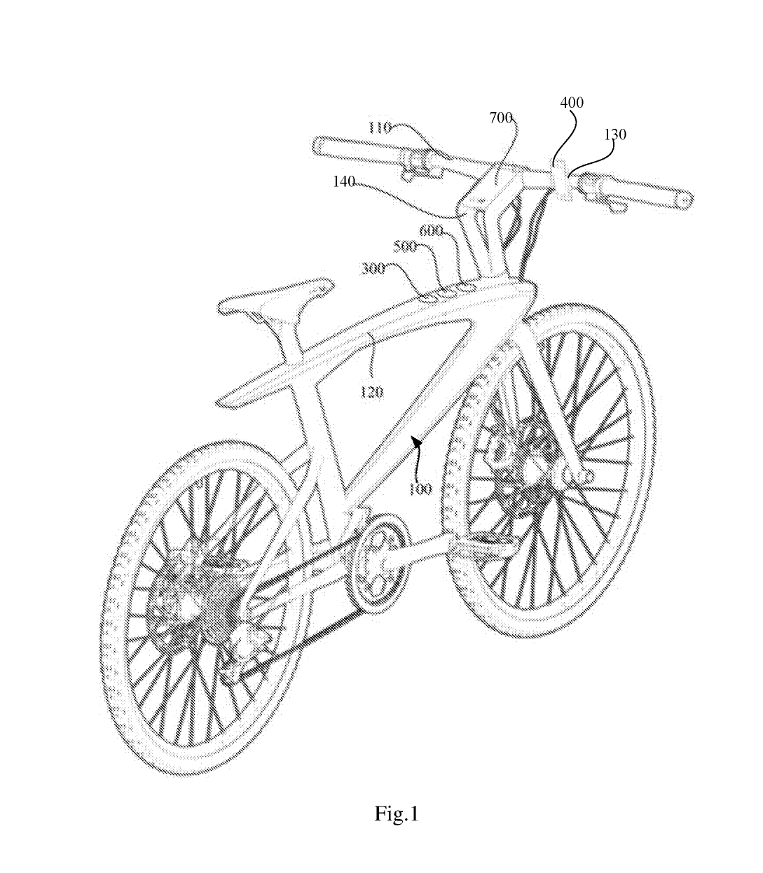

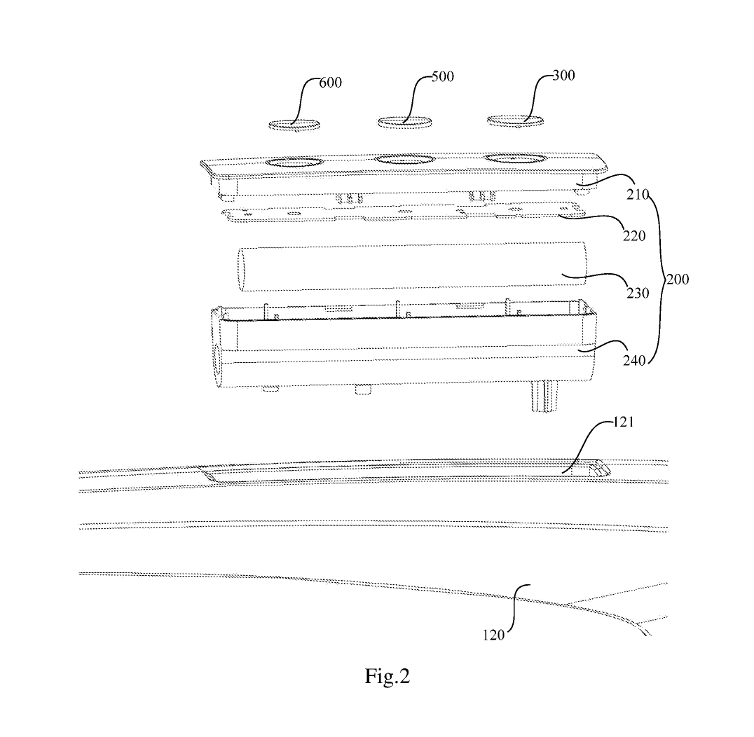

As illustrated in FIG. 1 and FIG. 2, a bicycle according to an embodiment of the invention includes a bicycle body 100, and further includes:

A main control apparatus 200, a button 300 arranged on the bicycle body 100, and an image acquisition device 400 fixed on the bicycle body 100, where the main control apparatus 200 is connected with the button 300 and the image acquisition device 400 so that the main control apparatus 200 is configured to control the image acquisition device 400 as a result of the button 300 being triggered.

Particularly the image acquisition device 400 is preferably centered on a bicycle handle 110 of the bicycle body 100, or can be arranged elsewhere in the bicycle body 100, but the embodiment of the invention will not be limited thereto; and the main control apparatus 200 can be arranged on the bicycle handle 110, or elsewhere in the bicycle body 100, but the embodiment of the invention will not be limited thereto.

In an embodiment, the image acquisition device 400 is fixed on the bicycle body 100, and the button 300 is arranged on the bicycle body 100, so that if a bicycler triggers the button 300 while bicycling, then the main control apparatus 200 can control the image acquisition device 400 as a result of the button 300 being triggered, and in this way, the bicycler can control the image acquisition device 400 by triggering the button 300 on the bicycle body while bicycling, so that the bicycler can operate conveniently, and be avoided from stopping bicycling to control the image acquisition device to take a picture or to produce a video, thus improving the experience of the bicycler.

Particularly, as illustrated in FIG. 2, a beam 120 of the bicycle body 100 is structured as a cavity, and as illustrated in FIG. 1, the button 300 is arranged on an upper wall of the beam 120 of the bicycle body 100, and a button cap of the button 300 is exposed on the surface of the upper wall of the beam 120. A button for another purpose can also be arranged on the beam, e.g., a button 500 configured to control a front lamp on the bicycle body 100, a button 600 configured to control an electronic lock on the bicycle body 100, etc., FIG. 2 illustrates the exposed cavity 121 of the beam with a part of the upper wall of the beam being removed.

In an embodiment of the invention, the button 300 is arranged on the beam 120 of the bicycle body 100 so that the bicycler can conveniently operate on the button 300 while bicycling. Moreover the button 300 can be arranged on the beam 120 without adding any further element on the bicycle body 100 and while making full use of a space of the beam 120 of the bicycle body 100. Of course, the button 300 can alternatively be arranged on the bicycle handle 110 of the bicycle body 100.

Particularly the button 300 is wired to the main control apparatus 200, and a cable between the button 300 and the main control apparatus 200 travels through the cavity inside the beam 120 of the bicycle body 100.

In an embodiment of the invention, the cable between the button 300 and the main control apparatus 200 travels through the cavity inside the beam 120 of the bicycle body 100 so that the cable can be avoided from being exposed outside the bicycle body 100 to thereby guarantee the lifetime of the cable.

Particularly as illustrated in FIG. 1, the image acquisition device 400 is fixed on the bicycle handle 110 of the bicycle body 100 through a first bracket 130 fixed on the bicycle handle 110 of the bicycle body 100.

In an embodiment of the invention, the image acquisition device 400 is fixed through the first bracket 130 so that the image acquisition device 400 can be fixed on the handle 110, and preferably the image acquisition device 400 can be removed from the first bracket 130.

Here the image acquisition device 400 can be a camera, a mobile phone capable of taking a picture and producing a video, or the like, and the image acquisition device illustrated in FIG. 1 is a mobile phone capable of taking a picture and producing a video.

Particularly the main control apparatus 200 is fixed on the bicycle handle of the bicycle body through a second bracket arranged on the bicycle handle 100 of the bicycle body 100.

Particularly as illustrated in FIG. 1, the bicycle according to the respective embodiments above further includes:

A third bracket 140, and a front component body 700 embedded at the third bracket 140, where the third bracket 140 is connected with the bicycle handle 110 of the bicycle body 100 and a bicycle frame of the bicycle body 100, and the main control apparatus 200 is arranged in the front component body 700 and connected with the front component body 700.

In an embodiment of the invention, a part of the bicycle body other than the bicycle handle 110 is collectively referred to as the bicycle frame.

The front component body 700 in an embodiment of the invention includes a first lower housing, a circuit board, a second battery, an upper housing, a display screen, and a touch screen arranged sequentially from the inner side to the outer side, where:

The first lower housing is connected with the bracket, the upper housing is connected with the first lower housing, and the circuit board and the second battery are located in an accommodating space defined by the first lower housing and the upper housing; and the display screen and the touch screen are arranged on the outside surface of the upper housing.

In an embodiment of the invention, a front component is added to the bicycle, and the state of the button 300 on the bicycle body being triggered, and the state of the image acquisition device being turned on or off can be displayed on a screen of the front component, and furthermore operations of playing music, navigation, bicycle management, etc., can be performed by operating on the screen of the front component, thus facilitating intelligent control on the bicycle.

Particularly as illustrated in FIG. 2, the beam 120 of the bicycle body 100 is structured as a cavity.

Here the main control apparatus 200 can be arranged in the cavity 121 of the beam 120, and the button 300 can be arranged on the main control apparatus 200, where the button cap of the button 300 is exposed on the surface of the upper wall of the beam 120 of the bicycle body. Of course, the button 300 can alternatively be arranged on the sidewall of the beam.

In an embodiment of the invention, the main control apparatus can be arranged in the cavity of the beam to thereby make full use of the space of the bicycle body and also avoid the main control apparatus from being exposed outside the bicycle body so that the lifetime of the main control apparatus can be improved to some extent. The button cap of the button is exposed on the surface of the upper wall of the beam of the bicycle body so that the user can operate on the button conveniently.

Particularly the main control apparatus 200 can be arranged in the cavity inside the beam as illustrated in FIG. 2, and the main control apparatus 200 includes a main control panel 210, a main control circuit board 220, and a first battery 230, where the main control panel 210 is fixed to the main control circuit board 220, the main control circuit board 220 is fixed to the first battery 230, and the button 300 is arranged on the main control panel 210; and the main control apparatus 200 can be arranged in the cavity 121 inside the beam. The main control apparatus 200 further includes a second lower housing 240 defining together with the main control panel 210 an accommodating cavity in which the first battery 230, the main control circuit board 220, etc., are installed; and in an embodiment of the invention, the main control panel 210 and the second lower housing 240 can protect the first battery 230, the main control circuit board 220, etc.

Particularly the bicycle according to the respective embodiments above further includes:

A light sensor connected with the main control apparatus, and an LED lamp fixed on the wall of the button cap of the button and connected with the main control apparatus; where the main control apparatus is further configured to control the LED lamp to be turned on or off, according to the strength of light acquired by the light sensor.

In an embodiment of the invention, a Light Emitting Diode (LED) lamp is arranged on the wall of the button cap, and controlled to be turned on or off, using the light sensor connected with the main control apparatus, so that if the bicycler is bicycling in an environment with dark light rays, then the LED lamp may be turned on to notify the bicycler of the position of the button 300 so that the bicycler can operate on the button conveniently. Preferably the LED lamp is embedded in the wall of the button cap so that the tip of the LED lamp is located at the same level as the wall of the button cap.

Particularly the main control apparatus 200 can be connected with the image acquisition device 400, particularly as follows:

The main control apparatus 200 is connected with the image acquisition device 400 through Bluetooth pairing; or

The main control apparatus 200 is connected with the image acquisition device 400 through WiFi.

Particularly the main control apparatus 200 is configured:

To control the image acquisition device 400 to start a photograph function, upon determining that the button 300 has been triggered for a first preset length of time; and to control the image acquisition device 400 to start a video function, upon determining that the button 300 has been triggered for a second preset length of time, where the first preset length of time is greater than the second preset length of time, or the first preset length of time is less than the second preset length of time.

In an embodiment of the invention, the main control apparatus controls the image acquisition device to start different functions, by detecting the state of the button 300 being triggered, so that the bicycler can enable the different functions of the image acquisition device by pressing on the button 300 on the beam while bicycling, thus improving the experience of the bicycler, where if the first preset length of time is greater than the second preset length of time, then the button 300 having been triggered for the first preset length of time can be referred to the button 300 having been pressed for a long period of time, and the button 300 having been triggered for the second preset length of time can be referred to the button 300 having been pressed for a short period of time; and if the first preset length of time is less than the second preset length of time, then the button 300 having been triggered for the first preset length of time can be referred to the button 300 having been pressed for a short period of time, and the button 300 having been triggered for the second preset length of time can be referred to the button 300 having been pressed for a long period of time.

In a particular application of the embodiment of the invention, when using the image acquisition device 400, if the image acquisition device is powered off, then the main control apparatus 200 may control the image acquisition device 400 to be powered on upon determining that the button 300 is triggered, and after the image acquisition device is powered on, the image acquisition device may control the photograph function of the image acquisition device 400 to be started upon determining that the button 300 has been pressed for a short period of time, and control the video function of the image acquisition device 400 to be started upon determining that the button 300 has been pressed for a long period of time, where if the video function of the image acquisition device is operating and the main control apparatus 200 determines that the button 300 has been pressed for a short period of time, then the main control apparatus may control the image acquisition device 400 to stop the video function from operating; and if the video function of the image acquisition device is operating and the main control apparatus 200 determines that the button 300 has been pressed for a long period of time, then the main control apparatus may determine that the operation on the button 300 is invalidated; or

After the image acquisition device is powered on, the image acquisition device may control the photograph function of the image acquisition device 400 to be started upon determining that the button 300 has been pressed for a long period of time, and control the video function of the image acquisition device 400 to be started upon determining that the button 300 has been pressed for a short period of time, where if the video function of the image acquisition device is operating and the main control apparatus 200 determines that the button 300 has been pressed for a long period of time, then the main control apparatus may control the image acquisition device 400 to stop the video function from operating; and if the video function of the image acquisition device is operating and the main control apparatus 200 determines that the button 300 has been pressed for a short period of time, then the main control apparatus may determine that the operation on the button 300 is invalidated.

Particularly the main control apparatus 200 is configured:

To control the image acquisition device 400 to start the photograph function upon determining that the button 300 has been triggered for a first preset number of times in a third preset length of time; and to control the image acquisition device 400 to start the video function upon determining that the button 300 has been triggered for a second preset number of times in the third preset length of time.

In the embodiment of the invention, the main control apparatus controls the image acquisition device to start the different functions by detecting the button 300 being triggered, so that the bicycler can enable the different functions of the image acquisition device by operating on the button 300 on the beam while bicycling, thus improving the experience of the bicycler, where the first preset number is preferably 1 and the second preset number is preferably 2, or the first preset number is preferably 2 and the second preset number is preferably 1. The first preset number and the second preset number can alternatively be other values, but will not be limited thereto, as long as the first preset number is different from the second preset number.

An embodiment of the invention further provides a method for controlling an image acquisition device, the method including:

Connecting a main control apparatus 200 with a button 300 and an image acquisition device 400, where the main control apparatus 200 controls the image acquisition device 400 as a result of the button 300 being triggered.

Preferably connecting the main control apparatus with the image acquisition device includes:

Connecting the main control apparatus with the image acquisition device through Bluetooth pairing; or

Connecting the main control apparatus with the image acquisition device through WiFi.

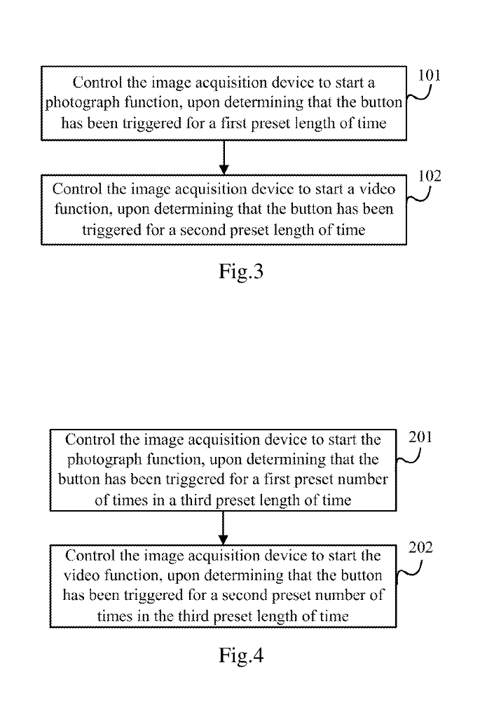

Preferably as illustrated in FIG. 3, the main control apparatus controlling the image acquisition device as a result of the button being triggered includes:

The operation 101 of controlling the image acquisition device to start a photograph function, upon determining that the button has been triggered for a first preset length of time; and

The operation 102 of controlling the image acquisition device to start a video function, upon determining that the button has been triggered for a second preset length of time.

Where the first preset length of time is greater than the second preset length of time, or the first preset length of time is less than the second preset length of time.

Preferably as illustrated in FIG. 4, the main control apparatus controlling the image acquisition device as a result of the button being triggered includes:

The operation 201 of controlling the image acquisition device to start the photograph function, upon determining that the button has been triggered for a first preset number of times in a third preset length of time; and

The operation 202 of controlling the image acquisition device to start the video function, upon determining that the button has been triggered for a second preset number of times in the third preset length of time.

The embodiments of the apparatus described above are merely exemplary, where the units described as separate components may or may not be physically separate, and the components illustrated as elements may or may not be physical units, that is, they can be collocated or can be distributed onto a number of network elements. A part or all of the modules can be selected as needed in reality for the purpose of the solution according to the embodiments of the invention. This can be understood and practiced by those ordinarily skilled in the art without any inventive effort.

Those ordinarily skilled in the art can appreciate that all or a part of the operations in the methods according to the embodiments described above can be performed by program instructing relevant hardware, where the programs can be stored in a computer readable storage medium, and the programs can perform one or a combination of the operations in the embodiments of the method upon being executed; and the storage medium includes an ROM, an RAM, a magnetic disc, an optical disk, or any other medium which can store program codes.

Lastly it shall be noted that the respective embodiments above are merely intended to illustrate but not to limit the technical solution of the invention; and although the invention has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the invention as claimed.

What is claimed is:

1. A bicycle, comprising a bicycle body, the bicycle further comprising:
a main control apparatus, a button arranged on the bicycle body, and an image acquisition device fixed on the bicycle body, wherein the main control apparatus is connected with the button and the image acquisition device so that the main control apparatus is configured to control the image acquisition device as a result of the button being triggered.

2. The bicycle according to claim 1, wherein a beam of the bicycle body is structured as a cavity, the button is arranged on an upper wall of the beam of the bicycle body, and a button cap of the button is exposed on the surface of the upper wall of the beam.

3. The bicycle according to claim 2, wherein the button is wired to the main control apparatus, and a cable between the button and the main control apparatus travels through the cavity inside the beam of the bicycle body.

4. The bicycle according to claim 1, wherein the image acquisition device is fixed on a bicycle handle of the bicycle body through a first bracket fixed on the bicycle handle of the bicycle body.

5. The bicycle according to claim 1, wherein the main control apparatus is fixed on a bicycle handle of the bicycle body through a second bracket arranged on the bicycle handle of the bicycle body.

6. The bicycle according to claim 1, wherein the bicycle further comprises:
a third bracket, and a front component body embedded at the third bracket, wherein the third bracket is connected with a bicycle handle of the bicycle body and a bicycle frame of the bicycle body, and the main control apparatus is arranged in the front component body and connected with the front component body.

7. The bicycle according to claim 1, wherein a beam of the bicycle body is structured as a cavity, the main control apparatus is arranged in the cavity of the beam, and the button is arranged on the main control apparatus so that a button cap of the button is exposed on the surface of the upper wall of the beam of the bicycle body.

8. The bicycle according to claim 7, wherein the main control apparatus comprises a main control panel, a main control circuit board, and a first battery, the main control panel is fixed to the main control circuit board, the main control circuit board is fixed to the first battery, and the button is arranged on the main control panel.

9. The bicycle according to claim 1, wherein the bicycle further comprises:
a light sensor connected with the main control apparatus, and an LED lamp fixed on the wall of a button cap of the button and connected with the main control apparatus; wherein the main control apparatus is further configured to control the LED lamp to be turned on or off according to the strength of light acquired by the light sensor.

10. The bicycle according to claim 1, wherein the main control apparatus is connected with the image acquisition device in such a way that:
the main control apparatus is connected with the image acquisition device through Bluetooth pairing; or
the main control apparatus is connected with the image acquisition device through WiFi.

11. The bicycle according to claim 1, wherein the main control apparatus is configured:
to control the image acquisition device to start a photograph function, upon determining that the button has been triggered for a first preset length of time; and to control the image acquisition device to start a video function, upon determining that the button has been triggered for a second preset length of time, wherein the first preset length of time is greater than the second preset length of time, or the first preset length of time is less than the second preset length of time.

12. The bicycle according to claim 1, wherein the main control apparatus is configured:
to control the image acquisition device to start the photograph function, upon determining that the button has been triggered for a first preset number of times in a third preset length of time; and to control the image acquisition device to start the video function, upon determining that the button has been triggered for a second preset number of times in the third preset length of time.

13. A method for controlling an image acquisition device, the method comprising:
connecting a main control apparatus with a button and an image acquisition device, wherein the main control apparatus controls the image acquisition device as a result of the button being triggered.

14. The method according to claim 13, wherein connecting the main control apparatus with the image acquisition device comprises:
connecting the main control apparatus with the image acquisition device through Bluetooth pairing; or
connecting the main control apparatus with the image acquisition device through WiFi.

15. The method according to claim 13, wherein the main control apparatus controlling the image acquisition device as a result of the button being triggered comprises:
controlling the image acquisition device to start a photograph function, upon determining that the button has been triggered for a first preset length of time; and
controlling the image acquisition device to start a video function, upon determining that the button has been triggered for a second preset length of time, wherein the first preset length of time is greater than the second preset length of time, or the first preset length of time is less than the second preset length of time.

16. The method according to claim 13, wherein the main control apparatus controlling the image acquisition device as a result of the button being triggered comprises:
controlling the image acquisition device to start the photograph function, upon determining that the button has been triggered for a first preset number of times in a third preset length of time; and
controlling the image acquisition device to start the video function, upon determining that the button has been triggered for a second preset number of times in the third preset length of time.
